(19) United States
(12) Patent Application Publication
(10) Pub. No.: US 2006/0012662 A1
(43) Pub. Date: Jan. 19, 2006

(54) Method, system, and computer readable medium for digital proofing

(76) Inventors: Pierre Ferland, Lachine (CA); Donald Eric Pederson, Plantation, FL (US)

Correspondence Address: Raffi Gostanian, Jr.;RG&Associates, 1103 Twin Creeks Drive, Allen, TX, 75013, US

(21) Appl. No.: 10/890,584

(22) Filed: Jul. 14, 2004

(51) Int. Cl. B41J 2/385

(52) U.S. Cl. 347/155

(57) ABSTRACT

A method, system, and computer readable medium for digital proofing comprises producing a digital proof on at least one substrate, wherein the substrate has been surface-treated with at least one coating, wherein an overall appearance of the substrate is unaltered by the coating, and wherein the substrate is adapted to be printed on a printing device.

### BACKGROUND

The present invention relates to digital proofing, and, more specifically to a method, system, and computer readable medium for producing a digital proof on at least one substrate.

The $30 billion corrugated container industry is undergoing radical change. Point-of-purchase packaging is increasingly used in the modern world of retailing, where expensive shelf and display space are critical. Fast-selling product lines require the highest standards of graphics to support product identity and brand loyalty. The growth of supermarket chains and the consolidation of many retailers, their awesome purchase power and the need for quality packaging to meet the marketing aspirations of branded products, has led the container industry to invest in enhanced printing.

Color projects demand thorough proofing (test sheet made to reveal errors or flaws, predict results on press and record how a printing job is intended to appear when finished) at all stages. The proofing process will demonstrate the digital integrity of the design file, and show the designer, printer and the client what the digital image will look like when it is to be printed. As such, the need for accurate proofing is even more important. When signed in approval, the digital proof typically becomes a binding contract for the printer to reproduce, in every possible way, the approved proof.

The difference between a resultant printing on a corrugated and folding carton container that a customer approves and what they actually receive are traditionally significantly different. Additional costs are almost always incurred due to the time involved attempting to resolve the problem, which usually cannot be corrected.

What is needed, therefore, is an ability to overcome the limitations associated with traditional proofing processes by proofing on the same substrate as the final product will be printed on.

### SUMMARY

The present invention relates to a method, system, and computer readable medium for producing a digital proof on at least one substrate. In one embodiment, a method for digital proofing comprises producing a digital proof on at least one substrate, wherein the substrate has been surface-treated with at least one coating, wherein an overall appearance of the substrate is unaltered by the coating, and wherein the substrate is adapted to be printed on a printing device.

In another embodiment, a method for digital proofing comprises producing a digital proof on at least one substrate, wherein the substrate has been surface-treated with at least one coating, wherein an appearance of the substrate is not altered, and wherein the digital proof emulates a manufacturing process of printing performed on the substrate.

In a further embodiment, a method for digital proofing comprises producing a digital proof and displaying at least one element related to the digital proof, wherein the element is at least one of: a dot-gain in emulation of a manufacturing process of printing on a given substrate, and a dot drop-off in emulation of press and printing plate capabilities.

In yet another embodiment, a computer readable medium comprises instructions for producing a digital proof, and displaying at least one element related to the digital proof, wherein the element is at least one of: a dot-gain and a dot drop-off, wherein the digital proof including the at least one element accurately resembles graphic elements of a finished post-print product.

In yet a further embodiment, a system for digital proofing comprises means for producing a digital proof on at least one substrate, wherein the substrate has been surface-treated with at least one coating, wherein an overall appearance of the substrate is unaltered by the coating, and wherein the substrate is adapted to be printed on a printing device.

### BRIEF DESCRIPTION OF THE DRAWINGS

FIG. 1 depicts a current example of a production process workflow diagram;

FIG. 2 depicts a method for digital proofing in accordance to a preferred embodiment of the present invention;

FIG. 3 depicts another method for digital proofing in accordance to a preferred embodiment of the present invention; and

FIG. 4 depicts a further method for digital proofing in accordance to a preferred embodiment of the present invention.

### DETAILED DESCRIPTION

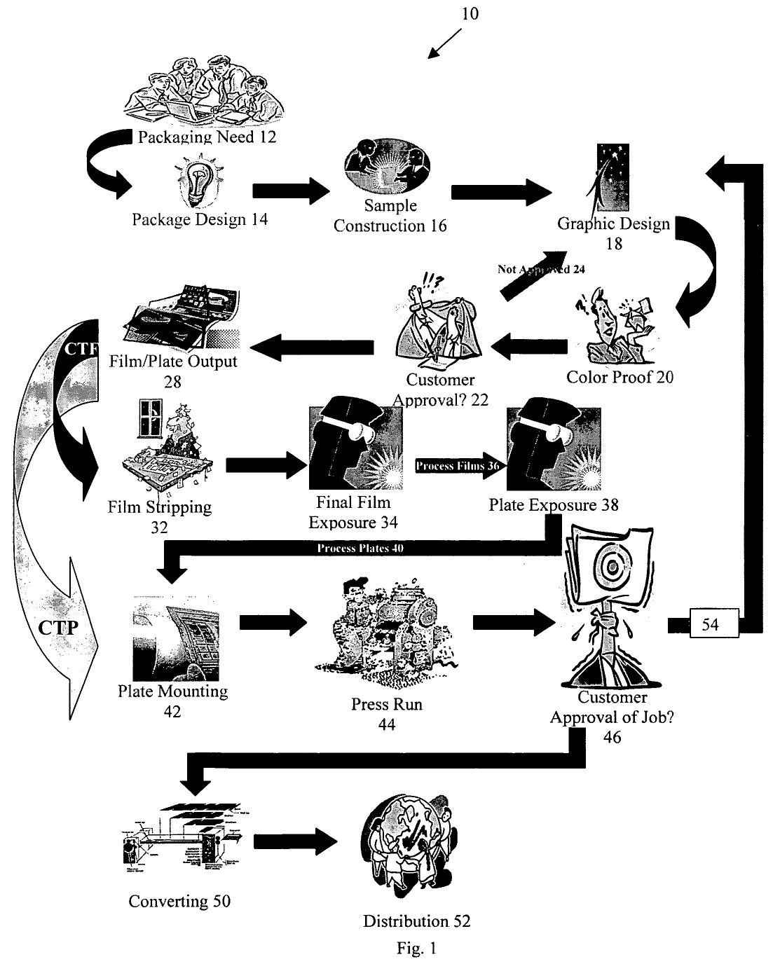

Referring now to FIG. 1, a production process diagram 10 is depicted. The process 10 begins at step 12 where manufacturers require packaging to deliver their product to market. The packaging needs to be functional, sturdy for shipping and (in some cases) able to display the product in a pleasing manner to capture the eye of the consumer. Package design 14 is based on the overall purpose of the packaging, i.e. solely for transport or for final display. Either way, every corrugated package must go through this phase. Usually, this is accomplished on a computer using Computer Aided Design (CAD) software. Sample construction 16 of the package is required to ensure the product that it is transporting and/or displaying is safe from damage during shipping. After the design has been completed using the CAD software, a sample maker (a plotting device that cuts the package from a flat sheet of corrugated board using a swiveling blade) creates the sample.

Graphic design 18 of the package could be for overall presentation to the end consumer or simply for shipping identification. Regardless of the overall use, it is required for proper placement of graphics or for the proper placement of a barcode or similar device to ensure automated scanning equipment can read the identification. Standard industry wide software can be used for this process such as Adobe Illustrator, Adobe Photoshop, Adobe Pagemaker, and Quark X-Press.

Proofing 20 of the graphic design is required to ensure the graphic elements fit the package design. Proofing is needed to verify the placement and color of the graphics for the press run and is considered an extremely important step of the process since it is easier and less expensive to catch any errors and correct them at this stage. Once a job is on the press, a customer can approve or disapprove 22 of the proof. If one or more errors is identified and the customer disapproves 24, the artwork would have to be corrected back at the design stage 18. A new film and/or plate will have to be produced, and the job will have to be rescheduled, re-setup and re-run on the press. This creates unacceptable delays and additional cost. The artwork is sent to a Color Postscript Raster Image Processor (RIP) to ensure graphic and color integrity. A limitation of such color proofing RIP's is that they do not represent traps, overprints and screening. Thus, it is desirable to represent traps, overprints, and screening and to color correct the artwork at the proofing step 20 and/or the customer approval step 22 step, as well as to show it on the final proof.

To finally correct the error(s), the artwork is sent digitally form the Color Postscript RIP to a large format plotter such as an Epson, Hewlett Packard, or Colorspan. A color plotter is much like a color desktop inkjet printer except it is more color accurate and allows for larger paper sizes. The artwork is then printed out on one large sheet of proofing paper. The customer will then receive the proof and verify the graphics, placement of the art, and color are correct. If the proof is not approved (signed-off) by the customer, the artwork goes back to the graphic design stage 18 to be re-adjusted to the customers' specifications. If the customer approves 26 (signs-off) of the proof, it is considered a contractual agreement between the printer and the customer that this artwork is what the customer will receive.

The artwork is again printed to a postscript RIP to be trapped, color separated and screened. Trapping includes spreading lighter colors slightly under darker colors to prevent gaps between the colors due to the final corrugated medium shifting in the press. Color separation is required if a job prints in more than one color. Each color element on the job is printed to its respective separation to ensure it will print in its target color on the press. The screening process is necessary for the reproduction of photographic elements to ensure proper reproduction on the press. Most corrugated printers still use film imagesetters to produce the separations for platemaking. This process is slowly being replaced in the corrugated world so in some instances they may image directly to the plate. An imagesetter will create a negative or positive film (depending on the platemaking process) implementing a highly focused laser, to be used in the exposure of the final plate for the printing press. If the imagesetter being used does not produce a film size 28 that matches the press size, the film will be processed 30 or sent to be stripped 32 and placed in its final positioning before plate exposure.

The film is run through a film processor (a device that runs the film through a chemical bath of developer, fixer, water rinse and a dryer) to create a workable piece of film for stripping or plate exposure. The stripping department receives the films and places the individual pieces in their respective positions by cutting and taping them onto a large orange mask (polyester material designed to block the light used in the exposure process). Each color has its own separation. Every color separation should line up properly to achieve the targeted result. The color proof is used for reference as the targeted result in this process.

Each separated stripped film 32 is then exposed in a vacuum frame (an exposure unit designed to perfectly seal two films together) on top of a film that is cut to the size of the cylinder of the press it is to be mounted on. This is done to create a final exposed film for each separation and has removed any shadows the taped and layered stripped film would leave on the plate during the plate exposure. The final exposed film 34 is run through a film processor 36 to create workable separations. The final exposed separated films are then used to create a plate. The film is placed over the light sensitive photopolymer plate material in a plate exposure unit 38. Light is used to expose the plate. A separate plate is made per color separation in order to place them in their respective stations on the press. The plate material is then run through a chemical bath in a plate processor 40 to create raised surfaces required for the ink on the press to adhere to and eventually transfer on the targeted corrugated medium being run through the press.

Each plate is then mounted 42 onto their respective cylinders. Using an adhesive, the mounters adhere the plates to the cylinder so they will not fly off while the press is running thus destroying the plate and possibly damaging the press. The cylinders are placed in their respective color stations on the press so each graphic element prints its proper color. Corrugated material is run through the press 44 so as it passes each station, the plate picks up the color it needs to distribute onto the medium. The plate with its respective color is “pressed” onto the corrugated medium, applying the color where it needs to be deposited thus creating an image on the material in the shape of its separation and in the color of that station on the press.

After the corrugated medium passes all of the stations on the press, the material is referenced back to the final “signed off” color proof to check for registration (the color separated stations lighting up), quality of the image, missing elements of the design, position and color match. The customer reviews 46 the final printed product and compares it to the “signed off proof” to make sure that the design, positioning and color they approved is what they are receiving from the printer (some customers supervise the press run for this purpose to prevent the entire job from running improperly). If the customer approves 48, the job will be fully run on the press, the printed corrugated material will go to converting 50 where it is made into the package desired. The customer's product is placed into the final package which is shipped out for distribution 52.

If the customer reviews 46 the final printed product and does not approve 54, the registration can be corrected on the press, image quality can be corrected either on press or the separation that is not correct may need to go back to platemaking 38, while all other corrections need to be handled back at graphic design 18. In such a situation, the entire time consuming and costly film and platemaking process needs to be repeated with the corrections.

As can be seen, there are various instances during the production process 10 where problems can arise. For example, at the proofing step 20 or the press run step 44 inaccuracies can force the production process 10 to be delayed. As such, producing the “signed-off” color proof that follows the job throughout the entire process is vitally important.

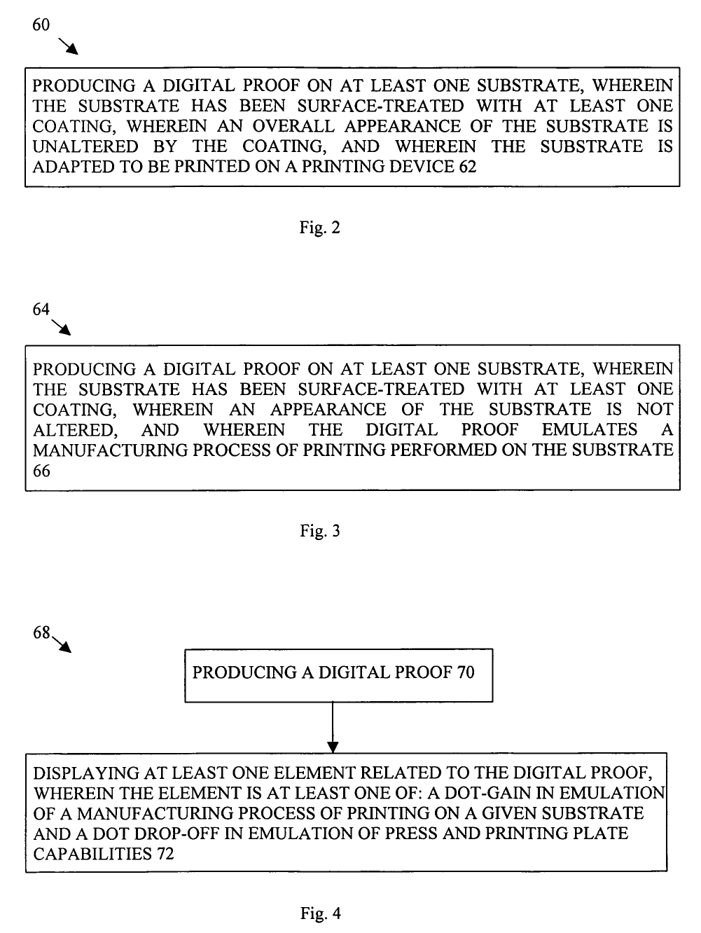

Referring now to FIG. 2, a method for digital proofing 60 comprises producing a digital proof (which is at least one of a pre-press proof and a design proof) on at least one substrate 62, wherein the substrate has been surface-treated with at least one coating, wherein an overall appearance of the substrate is unaltered by the coating, and wherein the substrate is adapted to be printed on a printing device. The coating is adapted to reduce the spreading of ink on a surface of the substrate and is adapted to reduce a penetration of ink into the substrate. The substrate includes at least one of a following substrate: a fine paper substrate used for commercial printing, a substrate used for printed packaging, and a substrate used for digital printing. Further, the substrate includes at least one of a following element: linerboard, folding carton, fine paper, label stock, tag stock, and flexible packaging stock. Still further, a following property of the substrate is unaltered: brightness, hue, finish, gloss, and smoothness.

The printing device that the substrate is adapted to be printed on is at least one of: a drop-on-demand inkjet printing device and a continuous inkjet digital printing device. An ink used in the printing is at least one of: a dye-based ink and a pigment-based ink, wherein the at least one ink is adapted to emulate a manufacturing process of printing, wherein the manufacturing process of printing is performed on the substrate, wherein the manufacturing process of printing is performed using the at least one ink.

Referring now to FIG. 3, a method for digital proofing 64 comprises producing a digital proof on at least one substrate 66, wherein the substrate has been surface-treated with at least one coating (which is preferably aqueous), wherein an appearance of the substrate is not altered, and wherein the digital proof emulates a manufacturing process of printing performed on the substrate.

Referring now to FIG. 4, a method for digital proofing 68 comprises producing a digital proof 70 and displaying at least one element related to the digital proof 72, wherein the element is at least one of: a dot-gain in emulation of a manufacturing process of printing on a given substrate and a dot drop-off in emulation of press and printing plate capabilities. At least one of a following file is used as an imprint: a PostScript file, a PDF file, and a TIFF file.

The method further comprises creating a half-tone proof from the at least one file, wherein the half-tone proof is adapted to display the at least one element, wherein the half-tone proof is adapted to emulate a manufacturing process of print, and wherein the digital proof is a half-tone proof. Still further, the method comprises displaying at least one other element related to the proof, wherein the other element is at least one of: a trap, a knockout, an overprint, and a halftone dot, wherein the digital proof including the at least one element is adapted to be printed, wherein the digital proof accurately resembles graphic elements of a finished post-print product, wherein the digital proof including the at least one element accurately resembles graphic elements of a finished post-print product, and wherein the printing is performed via at least one of: a printing press, a drop-on-demand inkjet printing device, and a continuous inkjet digital printing device.

The present invention also comprises a computer readable medium comprising instructions for: producing a digital proof and displaying at least one element related to the digital proof, wherein the element is at least one of: a dot-gain and a dot drop-off, wherein the digital proof including the at least one element accurately resembles graphic elements of a finished post-print product.

The present invention further comprises a system for digital proofing comprising: means for producing a digital proof on at least one substrate, wherein the substrate has been surface-treated with at least one coating, wherein an overall appearance of the substrate is unaltered by the coating, and wherein the substrate is adapted to be printed on a printing device. The computer readable medium and the system of the present invention can work independently or in conjunction with one another.

The following sections describe further aspects of the present invention including a Tag Image File Format (TIFF) Press Gain Representation for Inkjet Plotters and a TIFF Dot Drop-Off Representation for Inkjet Plotters.

TIFF Press Gain Representation for Inkjet Plotters

In the prepress industry, designers and printers rely on an inkjet color proof that shows the final layout and color of the artwork to print on press. As previously described, the proof will follow a job all the way through the production cycle to final customer approval of the printed piece. This makes it necessary to have a proof that is accurate to the press it is printed on. Ink jet color proofing is preferred due to the low-cost nature of this medium. Artwork is digitally sent to a RIP to be processed and subsequently printed out to a large format plotter. The RIP not only processes the image, but also controls the final color the image will print on the proof. Some Proofing RIPs will also represent the actual dot, linescreen, trap and overprint of the final printed piece. This allows for a closer representation of the artwork before it goes to press.

Even though the text, lines and dot are represented by some color proofing RIPs, these RIPs are missing one key element that makes them a total solution: the representation of Press Gain. Press Gain occurs on every press, some more than others. The term Press Gain refers to the increase in size of a printed line, text or dot from the printing plate to the final printed piece on its respective medium. This is caused by a combination of the amount of ink that is placed on the plate before impression, and the pressure used by the press to make the impression onto the medium. A good example of this is a common hand inkpad and address stamp. If you place the rubber end of the hand stamp onto an inkpad once and then gently apply pressure to the stamp on the paper you are transferring the ink to, you get a good image of that stamp on the paper. If you put a large amount of ink to the rubber end and then apply a lot of pressure to the stamp when transferring the image to the paper, you get a very heavy and splotchy final image. This is due to the ink being squeezed onto the paper. Since all of the ink cannot be completely absorbed by the paper, it gets pushed out around the edge of the image that is on the stamp thus “gaining” in size.

Since every press prints differently because of inconsistencies in parts or manufacture, some print shops go through a process called “fingerprinting” of the press. Fingerprinting allows the print shop to identify how each station of the press prints due to the ink laydown and pressure of the cylinder. Although cylinder pressure can be adjusted, most print shops would rather maintain one pressure and make adjustments for it on the prepress end. This creates more consistency in predicting the way a press will run a job. Fingerprinting charts out this trait on the press and gives the prepress department the information they need to adjust the line, text and dot weight. Prepress can then compensate for the press gain they will receive on the printing press.

Although the fingerprinting process is known, it has not been utilized on the proofing side. Doing so would enable the press operator reproduce the proof on the final printed piece. The Proofing RIP of the present invention addresses this problem by adding press gain to the file while it is postscripting. Unfortunately, this can cause difficulties. Since the Proofing RIP of the present invention is postscripting the file, it is not applying the same screen angle to the job that the final color separation RIP will apply, unless a prepress shop is using the Proofing RIP of the present invention for their final color separated output to film or plate as well. Most shops already have a color separation RIP in place and are unwilling to change this process due to training issues or comfort and confidence in their existing system.

These shops have migrated towards a TIFF system that allows their final color separation RIP to send these separated files to a color RIP system. This ensures they look exactly the same as they will on film and/or plate. The color RIP system then reassembles the TIFF files together, and prints them in their respective colors to a color plotter. This presents an even bigger problem: the files being sent from the color separation RIP to the Color Proofing RIP have already been adjusted for press gain. Because of this adjustment, they no longer represent how the image will expand on the press when printed. The press operator now has a moving target.

In order to solve the aforementioned problem, the present invention includes a TIFF-based Press Gain software that will work in conjunction with any TIFF-based color proofing RIP. The TIFF-based Press Gain software analyzes the Press Gain adjustment curve used to generate the TIFF separations by the color separation RIP, and compensates the image to represent how it will grow on the press. The software adjusts the file before the color proofing RIP takes the separated files and reassembles them for color proofing and accepts the files through shared “Hot” folders that the software monitors for files that have been transferred. Once the software detects a file, it will process it and actually “grow” the image. This is accomplished by adding extra pixels around the image area. Once the software has completed this task, it will transfer the file to any specified folder that is rendered “Hot” by the color proofing RIP software being used. The color proofing RIP software will then reassemble the file, process it and then print it to a color plotter.

TIFF Dot Drop-Off Representation for Inkjet Plotters

Flexographic and corrugated printing uses a similar plate on the press. This plate is known as a photopolymer plate, which is made up of a polymer that hardens when exposed to UV light. A negative film is placed on top of the photopolymer and when the UV light exposes the plate, all of the areas not blacked out by the overlaying film negative will harden. If the plate-making department is using a sheet photopolymer, the plate will then process through a chemical bath to remove the area not hardened by the UV light. When the plate is processed with the chemistry, it is also scrubbed with brushes to help in the removal of the unwanted plate area. Although the plate can withstand this very harsh treatment, some imperfections to this process emerge. One problem that has been accepted by printers everywhere as “just one of those things to work around” is Dot Drop-off.

Dot drop-off occurs when a screen dot in an image or a vignette is too small to withstand the scrubbing process and falls off of the plate. This usually occurs in around the 1% to 10% of the dot area depending on the plate maker's equipment and the quality of the photopolymer plate. Some plate makers have been able to reduce this problem to around 1% to 5% of the dot area, but the problem remains inevitable. If the dot falls off the plate, it won't print on the press resulting in a splotchy look to the image or vignette in these “problem areas.” Most plate makers that have an in-house art department could adjust for the dot drop-off problem in advance before sending the file to the color separation RIP. However, in an industry that relies primarily on designers and not printers to create the original artwork, this problem will continue to present itself. Most designers are not aware of this flaw in the printing process, and therefore do not compensate for the problem before the art is approved by the customer. This presents an issue to the printer since the customer will never get an exact representation on the press of what was originally designed.

The customer will need to see this issue in their artwork before it goes to the press. The best place for dot drop-off to be identified is in the ink jet proofing process. Identifying this earlier in the process will greatly reduce the cost of artwork preparation and sales representative intervention. The Color Proofing RIP of the present invention identifies and represents this issue on a plotter proof. As explained earlier, there are color proofing RIPs available that will print a dot. However, how effective are they if they show a dot that will not make it through the plate making process, and, therefore, not print on press? A such, Color Proofing RIP of the present invention emulates this problem while postscripting the file. Again, this can only be a true representation if the files ultimately print to separations or plate from the Proofing RIP of the present invention.

For shops that have a TIFF based RIP system, the TIFF-based software of the present invention eliminates the dots in the problem areas on files before they are processed by the color proofing RIP. A separation is sent to the Dot Drop Off software of the present invention's network shared “Hot” folder. The Dot Drop-Off software identifies dots of a particular size or pixel amount on the original color separated TIFF, and erases them from the image. The file is then placed in another “Hot” folder for further processing beyond that of other production software being used. This will result in a more accurate representation of the final printed image on an inexpensive screened color proof. The customer will then see the issues with their artwork fully illustrated, and correct any problem before it continues further into the production process.

Although an exemplary embodiment of the method, system and computer readable medium of the present invention has been illustrated in the accompanied drawings and/or described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for digital proofing, comprising:
producing a digital proof on at least one substrate;
wherein the substrate has been surface-treated with at least one coating;
wherein an overall appearance of the substrate is unaltered by the coating; and
wherein the substrate is adapted to be printed on a printing device.

2. The method of claim 1 wherein the substrate includes at least one of a following substrate:
a fine paper substrate used for commercial printing;
a substrate used for printed packaging; and
a substrate used for digital printing.

3. The method of claim 1, wherein the substrate includes at least one of a following element:
linerboard;
folding carton;
fine paper;
label stock;
tag stock; and
flexible packaging stock.

4. The method of claim 1, wherein a following property of the substrate is unaltered:
brightness;
hue;
finish;
gloss; and
smoothness.

5. The method of claim 1, wherein the printing device is at least one of:
a drop-on-demand inkjet printing device; and
a continuous inkjet digital printing device.

6. The method of claim 1, wherein the coating is adapted to reduce the spreading of ink on a surface of the substrate.

7. The method of claim 1, wherein the coating is adapted to reduce a penetration of ink into the substrate.

8. The method of claim 1, wherein an ink used in the printing is at least one of:
a dye-based ink; and
a pigment-based ink; and

9. The method of claim 8, wherein the at least one ink is adapted to emulate a manufacturing process of printing.

10. The method of claim 9, wherein the manufacturing process of printing is performed on the substrate.

11. The method of claim 10, wherein the manufacturing process of printing is performed using the at least one ink.

12. The method of claim 1, wherein the digital proof is at least one of:
a pre-press proof; and
a design proof.

13. A method for digital proofing, comprising:
producing a digital proof on at least one substrate;
wherein the substrate has been surface-treated with at least one coating;
wherein an appearance of the substrate is not altered; and
wherein the digital proof emulates a manufacturing process of printing performed on the substrate.

14. The method of claim 13, wherein the coating is aqueous.

15. A method for digital proofing, comprising:
producing a digital proof; and
displaying at least one element related to the digital proof, wherein the element is at least one of:
a dot-gain in emulation of a manufacturing process of printing on a given substrate; and
a dot drop-off in emulation of press and printing plate capabilities.

16. The method of claim 15 comprising using at least one of a following file as an imprint:
a PostScript file;
a PDF file; and
a TIFF file.

17. The method of claim 16 comprising creating a half-tone proof from the at least one file.

18. The method of claim 17, wherein the half-tone proof is adapted to display the at least one element.

19. The method of claim 17, wherein the half-tone proof is adapted to emulate a manufacturing process of print.

20. The method of claim 17, wherein the digital proof is a half-tone proof.

21. The method of claim 15 comprising displaying at least one other element related to the proof, wherein the other element is at least one of:
a trap;
a knockout;
an overprint; and
a halftone dot.

22. The method of claim 15, wherein the digital proof including the at least one element is adapted to be printed.

23. The method of claim 15, wherein the digital proof accurately resembles graphic elements of a finished post-print product.

24. The method of claim 15, wherein the digital proof including the at least one element accurately resembles graphic elements of a finished post-print product.

25. The method of claim 22, wherein the printing is performed via at least one of:
a printing press;
a drop-on-demand inkjet printing device; and
a continuous inkjet digital printing device.

26. A computer readable medium comprising instructions for:
producing a digital proof; and
displaying at least one element related to the digital proof, wherein the element is at least one of:
a dot-gain; and
a dot drop-off;
wherein the digital proof including the at least one element accurately resembles graphic elements of a finished post-print product.

27. A system for digital proofing, comprising:
means for producing a digital proof on at least one substrate;
wherein the substrate has been surface-treated with at least one coating;
wherein an overall appearance of the substrate is unaltered by the coating; and
wherein the substrate is adapted to be printed on a printing device.
